(19) United States
(12) Patent Application Publication
(10) Pub. No.: US 2022/0112422 A1
(43) Pub. Date: Apr. 14, 2022

(54) HYDRAULIC FRACTURING IN HYDROCARBON-BEARING RESERVOIRS

(71) Applicant: Saudi Arabian Oil Company, Dhahran (SA)

(72) Inventors: Feng Liang, Cypress, TX (US); Hui-Hai Liu, Katy, TX (US); Yanhui Han, Katy, TX (US); Kirk M. Bartko, Houston, TX (US); Rajesh Kumar Saini, Cypress, TX (US)

(21) Appl. No.: 17/494,387

(22) Filed: Oct. 5, 2021

Related U.S. Application Data
(60) Provisional application No. 63/089,944, filed on Oct. 9, 2020.

(51) Int. Cl. C09K 8/00; C09K 8/80

(52) U.S. Cl. CPC C09K 8/00; C09K 8/80

(57) ABSTRACT

A subterranean zone can be treated by introducing a mixture of an acid-generating material and a proppant (for example, in a pad fluid or a pre-pad fluid) to the subterranean zone. Fractures and microfractures are created in the subterranean zone using the mixture of the acid-generating material and the proppant. The proppant is positioned within the fractures and microfractures to keep them open.

### CROSS REFERENCE TO RELATED APPLICATION(S)

This application claims the benefit of priority to U.S. Provisional Patent Application No. 63/089,944, filed Oct. 9, 2020, the contents of which are hereby incorporated by reference.

### TECHNICAL FIELD

This disclosure relates to hydraulic fracturing hydrocarbon-bearing reservoirs, and more specifically, in tight gas reservoirs (for example, carbonate reservoirs).

### BACKGROUND

Low permeability reservoirs that produce mainly dry natural gas are commonly called tight gas reservoirs. On an individual well bases, a well in a tight gas reservoir will typically produce less gas over a longer period of time than one would expect from a well completed in a higher permeability, conventional reservoir. In many cases, hydrocarbon production from low permeability reservoirs rapidly declines during the first year of production. Hydraulic fracturing processes have been used to stimulate such tight gas reservoirs and improve hydrocarbon production.

### SUMMARY

This disclosure describes technologies relating to hydraulic fracturing in hydrocarbon-bearing reservoirs, and more specifically, in tight gas reservoirs (for example, carbonate reservoirs).

Certain aspects of the subject matter described here can be implemented as a method for treating a subterranean zone (for example, a tight carbonate subterranean zone). An acid-generating material and a proppant is introduced to the subterranean zone. Fractures are created in the subterranean zone using the acid-generating material. The proppant is positioned within the created fractures to keep the fractures open. A ratio of an average diameter of the acid-generating material to an average diameter of the proppant is in a range of from 1:1 to 5:1. The proppant can be, for example, a small-sized proppant having a maximum dimension less than or equal to 150 micrometers (μm), less than or equal to 1 μm, or less than or equal to 100 nanometers (nm).

This, and other aspects, can include one or more of the following features. The acid-generating material and the proppant can be mixed to form a mixture, and the mixture can be introduced to the subterranean zone.

The mixture can include a single layer or multiple layers. Each of the layers can include the acid-generating material and the proppant.

The subterranean zone can include carbonate mineral.

An acid can be generated in the subterranean zone with the acid-generating material. The carbonate mineral can be reacted with the generated acid.

The acid-generating material can include a degradable ester.

The degradable ester can include polylactic acid, polyglycolic acid, or combinations thereof.

The proppant can have a maximum dimension less than or equal to 150 micrometers (μm).

The proppant can have a maximum dimension less than or equal to 100 μm.

The proppant can have a maximum dimension less than or equal to 1 μm.

The proppant can have a maximum dimension less than or equal to 100 nanometers (nm).

The proppant can be coated with the acid-generating material to form coated proppant, and the coated proppant can be introduced to the subterranean zone.

The ratio of the average diameter of the acid-generating material to the average diameter of the proppant can be in a range of from 1.5:1 to 3:1 or in a range of from 2:1 to 3:1.

A ratio of a density of the proppant to a density of the acid-generating material can be in a range of from 1:1 to 2.5:1 or in a range of from 1.5:1 to 2.5:1.

The average diameter of the proppant can be less than or equal to 150 micrometers.

Certain aspects of the subject matter described here can be implemented as a method for treating a subterranean zone (for example, a tight carbonate subterranean zone). The subterranean can have natural microfractures. A mixture of an acid-generating material and a small-sized proppant is introduced to the subterranean zone, for example, with pad or pre-pad fluids. The acid-generating material enlarges the flow pathways within the natural microfractures by degradation initiated by downhole temperatures and interaction with the carbonate formation. The acid-generating material can also create induced microfractures in the subterranean zone. The small-sized proppant has a maximum dimension less than or equal to 150 μm, less than or equal to 1 μm, or less than or equal to 100 nm. The small-sized proppant is positioned within the natural microfractures and/or the induced microfractures to keep the microfractures open. A ratio of an average diameter of the acid-generating material to an average diameter of the small-sized proppant is in a range of from 1:1 to 5:1.

Certain aspects of the subject matter described here can be implemented as a method for treating a subterranean zone (for example, a tight carbonate subterranean zone). The subterranean zone has natural microfractures. A mixture of an acid-generating material and a small-sized proppant is introduced to the subterranean zone. A ratio of an average diameter of the acid-generating material to an average diameter of the proppant is in a range of from 1:1 to 5:1. The small-sized proppant has a maximum dimension less than or equal to 150 150 μm, less than or equal to 1 μm, or less than or equal to 100 nm. Induced microfractures are created in the subterranean zone by using the mixture of the acid-generating material and the small-sized proppant. The small-sized proppant is positioned within both the natural microfractures and the induced microfractures to keep the natural microfractures and the induced microfractures open.

Certain aspects of the subject matter described here can be implemented as a composition for treating a subterranean zone that includes carbonate mineral (for example, a tight carbonate subterranean zone). The composition includes an acid-generating material and a proppant. The composition can be included in a pad or pre-pad fluid, for example, during an engineering process. The acid-generating material includes a degradable ester. The acid-generating material is configured to generate an acid that reacts with the carbonate mineral which results in creating fractures (for example, induced microfractures) in the subterranean zone. The acid-generating material enlarges the flow pathways within the natural microfractures by degradation initiated by downhole temperatures and interaction with the carbonate formation. The acid-generating material can also create induced microfractures in the subterranean zone. A ratio of an average diameter of the acid-generating material to an average diameter of the proppant is in a range of from 1:1 to 5:1. A ratio of a density of the proppant to a density of the acid-generating material is in a range of from 1:1 to 2.5:1. The proppant can be, for example, a small-sized proppant having a maximum dimension less than or equal to 150 micrometers (μm), less than or equal to 1 μm, or less than or equal to 100 nanometers (nm).

This, and other aspects, can include one or more of the following features.

The ratio of the average diameter of the acid-generating material to the average diameter of the proppant can be in a range of from 1.5:1 to 3:1 or in a range of from 2:1 to 3:1.

The ratio of the density of the proppant to the density of the acid-generating material is in a range of from 1.5:1 to 2.5:1.

The composition can include a single layer or multiple layers. Each of the layers can include the acid-generating material and the proppant.

The degradable ester can include polylactic acid, polyglycolic acid, or combinations of these.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a flow chart of a method for treating a subterranean zone.

FIG. 1B is a schematic showing a flow profile of a mixture of acid-generating material and proppant settling within a fracture of a subterranean zone.

FIGS. 2A & 2B are schematics showing stages of treating a subterranean zone using a mixture of acid-generating material and proppant in multiple layer packing.

FIGS. 3A & 3B are schematics showing stages of treating a subterranean zone using a mixture of acid-generating material and proppant in single layer packing.

FIGS. 4A & 4B are schematics showing stages of treating a subterranean zone using proppant coated with an acid generating material in a single layer.

FIG. 5 is a schematic of a fracture without proppant.

FIG. 6 is a schematic of laminar flow within a fracture at steady state.

FIG. 7 is a schematic of fluid flow within a fracture packed with proppant at steady state.

FIG. 8A is a schematic of a fracture packed with proppant.

FIG. 8B is a schematic of fluid flow within the fracture of FIG. 8A at steady state with some of the proppant removed.

FIG. 9 is a schematic showing an example composite core assembly.

FIG. 10A is a photograph of sand and an acid-generating material packed on a rock sample.

FIG. 10B is a surface scan of the rock sample of FIG. 10A prior to being packed with the sand and the acid-generating material.

FIG. 10C is a magnified scan of the area in the rectangle of FIG. 10B.

FIG. 10D is a magnified scan of the area in the rectangle of FIG. 10C.

FIG. 10E is a height profile along the dashed line of FIG. 10C.

FIG. 10F is a height profile along the dashed line of FIG. 10D.

FIG. 11A is a surface scan of the rock sample of FIG. 10A after undergoing core flooding and subsequent removal of the sand.

FIG. 11B is a magnified scan of the area in the rectangle of FIG. 11A.

FIG. 11C is a magnified scan of the area in the rectangle of FIG. 11B.

FIG. 11D is a height profile along the dashed line of FIG. 11B.

FIG. 11E is a height profile along the dashed line of FIG. 11C.

FIG. 12A is a photograph of the rock sample of FIG. 10A after undergoing core flooding and subsequent removal of the sand and undissolved acid-generating material.

FIG. 12B is a surface scan of the rock sample of FIG. 12A.

FIG. 12C is a magnified scan of the area in the rectangle of FIG. 12B.

FIG. 12D is a magnified scan of the area in the rectangle of FIG. 12C.

FIG. 12E is a height profile along the dashed line of FIG. 12C.

FIG. 12F is a height profile along the dashed line of FIG. 12D.

FIG. 13A is a photograph of an acid-generating material on a rock sample.

FIG. 13B is a surface scan of the rock sample of FIG. 13A prior to being treated with the acid-generating material.

FIG. 13C is a magnified scan of the area in the rectangle of FIG. 13B.

FIG. 13D is a magnified scan of the area in the rectangle of FIG. 13C.

FIG. 13E is a height profile along the dashed line of FIG. 13C.

FIG. 13F is a height profile along the dashed line of FIG. 13D.

FIG. 14A is a photograph of the rock sample of FIG. 13A after undergoing core flooding and subsequent removal of undissolved acid-generating material.

FIG. 14B is a surface scan of the rock sample of FIG. 14A.

FIG. 14C is a magnified scan of the area in a rectangle of FIG. 14B.

FIG. 14D is a magnified scan of the area in another rectangle of FIG. 14B.

FIG. 14E is a height profile along the dashed line of FIG. 14C.

FIG. 14F is a height profile along the dashed line of FIG. 14D.

FIG. 15A is a photograph of sand and an acid-generating material on a rock sample.

FIG. 15B is a surface scan of the rock sample of FIG. 15A prior to being treated with the sand and the acid-generating material.

FIG. 15C is a magnified scan of the area in the rectangle of FIG. 15B.

FIG. 15D is a magnified scan of the area in the rectangle of FIG. 15C.

FIG. 15E is a height profile along the dashed line of FIG. 15C.

FIG. 15F is a height profile along the dashed line of FIG. 15D.

FIG. 16A is a photograph of the rock sample of FIG. 15A, after undergoing core flooding and subsequent removal of the sand and undissolved acid-generating material.

FIG. 16B is a surface scan of the rock sample of FIG. 16A.

FIG. 16C is a magnified scan of the area in a rectangle of FIG. 16B.

FIG. 16D is a magnified scan of the area in another rectangle of FIG. 16B.

FIG. 16E is a height profile along the dashed line of FIG. 16C.

FIG. 16F is a height profile along the dashed line of FIG. 16D.

FIG. 17A is a schematic illustrating fluid flow in a fracture without proppant.

FIG. 17B is a schematic illustrating fluid flow in a fracture with proppant.

FIG. 17C is a schematic illustrating fluid flow in a fracture with proppant and void space generated by an acid-generating material.

FIG. 18 is a three-dimensional schematic illustrating fluid flow in a fracture packed with single layer of proppant.

FIG. 19 is a graph showing various combinations of acid-generating material diameter, proppant diameter, and proppant density.

### DETAILED DESCRIPTION

Carbonate reservoirs make up approximately 70% of oil reservoirs and approximately 90% of gas reservoirs in the Middle East region. Hydraulic fracturing processes have been used to stimulate reservoirs to improve hydrocarbon production. In a typical hydraulic fracturing process, multi-million gallons of water-based fracturing fluids are used as carrying fluids to transport proppants into the hydraulically-induced fractures. It has been estimated that for some hydraulic fracturing processes, only about 10% to 35% of the fracturing fluids flow back to the well, while the rest of the fluids are retained within the formation. The imbibition of fracturing fluids into the rock matrix has been considered to be one of the main mechanisms that cause fracturing fluid loss and reservoir damage. Fracturing fluids imbibed into the rock matrix can invade the permeability of the gas/oil phase, thereby decreasing the productivity of a well. Natural fractures and induced, un-propped fractures (that is, fractures that have been created but have not been propped open, for example, by a proppant) have a tendency to close after release of hydraulic pressure during production from a well.

Dissolution of sulfate and carbonate minerals within carbonate reservoirs can increase permeability of the reservoir rock. The subject matter described in this disclosure utilize acid-generating material and proppant together (for example, in pad or pre-pad fluids) to increase the permeability of tight gas reservoirs, for example, by improving fluid flow in induced or naturally existing far-field microfractures. The acid-generating material and the proppant can be used to further increase the matrix permeability by improving mineral dissolution ability of the imbibed fluid to the formation. The materials described in this disclosure can dissolve minerals on fracture (and micro-fracture) surfaces and can penetrate into the rock matrix, so that hydrocarbon production from the formation can be increased. The materials described in this disclosure can generate additional fractures (and micro-fractures) by reacting with minerals that make up the formation. The proppants can more easily occupy the induced microfractures and in some cases, even the natural micro-fractures within the formation. The subject matter described herein can be implemented to realize one or more of the following advantages. Connectivity between natural and induced microfractures in primary and far-field fracture networks can be maintained and improved to enhance well production. The subject matter described can be implemented in tight carbonate reservoirs to improve and maintain fracture networks in such reservoirs.

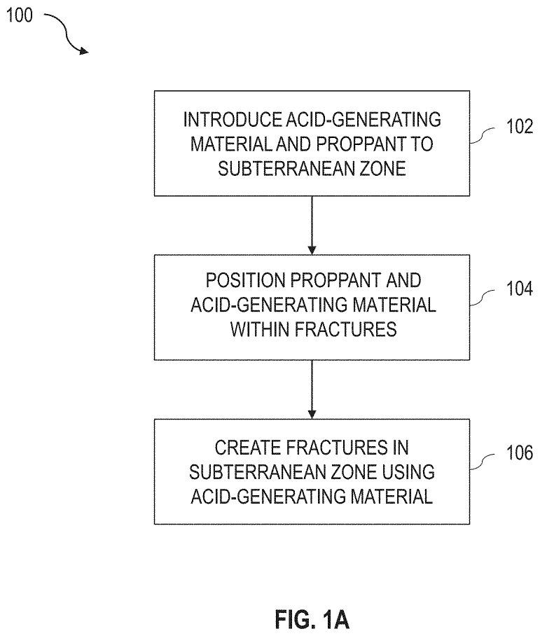

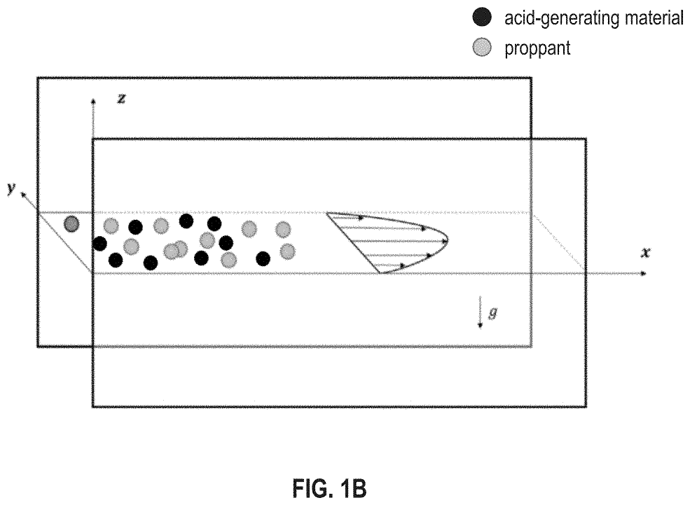

FIG. 1A is a flow chart of a method 100 for treating a subterranean zone. The subterranean zone can include a tight gas reservoir. For example, the subterranean zone can include a carbonate rock formation, which can include carbonate mineral. At step 102, a mixture of an acid-generating material and a proppant is introduced to the subterranean zone. The acid-generating material can be, for example, pumped downhole through a tubing into the subterranean zone. The acid-generating material and the proppant can be pumped and mixed together into the subterranean zone. In some implementations, the acid-generating material and the proppant are mixed before they are pumped together into the subterranean zone. In some implementations, the acid-generating material and the proppant are simply pumped simultaneously together into the subterranean zone, and the acid-generating material and the proppant mix while traveling into the subterranean zone. Uniform mixing of the acid-generating material and the proppant at the desired destination within the subterranean zone can maximize connectivity of proppant-supported microfractures (natural and/or induced).

A ratio of an average diameter of the acid-generating material to an average diameter of the proppant is in range of from 1:1 to 5:1. In some implementations, the ratio of the average diameter of the acid-generating material to the average diameter of the proppant is in a range of from 1.5:1 to 5:1 or from 2:1 to 3:1. In some implementations, a ratio of a density of the proppant to a density of the acid-generating material is in a range of from 1:1 to 2.5:1 or from 1.5:1 to 2.5:1. The relationship between densities of the proppant and acid-generating material and the relationship between average diameters of the proppant and acid-generating material affect the relative settling velocities of the proppant and acid-generating material within the subterranean zone, for example, within fractures of the subterranean zone. The ratio ranges of the average diameters and densities of the acid-generating material and proppant disclosed here can allow for the settling velocities of the acid-generating material and proppant to be substantially the same or similar within the subterranean zone, for example, within fractures of the subterranean zone.

The acid-generating material and the proppant can be mixed to form a mixture, and the mixture can be introduced to the subterranean zone. For example, the acid-generating material and the proppant can be mixed to form a mixture before being introduced to the subterranean zone, and then the mixture can be pumped into the subterranean zone. In some implementations, the mixture of acid-generating material and proppant includes multiple layers, and each of the layers includes acid-generating material and proppant. In some implementations, the mixture of acid-generating material and proppants forms a single layer that includes acid-generating material and proppant. In some implementations, the proppant is coated with the acid-generating material to form coated proppant, and the coated proppant is introduced to the subterranean zone.

The acid-generating material and the proppant can be introduced to the subterranean zone with another fluid. For example, the acid-generating material and the proppant can be introduced to the subterranean zone with a drilling fluid, a stimulation fluid, a fracturing fluid, a remedial treatment fluid, a pad fluid, a pre-pad fluid, or combinations thereof. The acid-generating material can be a delayed acid-generating material. For example, the acid-generating material does not generate acid until after the acid-generating material has been introduced to the subterranean zone. The acid-generating material can be an acid precursor, that is, a compound that participates in a chemical reaction that produces an acid. The acid-generating material can be a material that can degrade to produce an acid as a degradation product. The acid-generating material can be in the form of a solid. The acid-generating material can include an ester, such as a degradable polyester (for example, polylactic acid, polyglycolic acid, and copolymers thereof). Esters have hydrolysable ester bonds that can be cleaved to produce acid. For example, polyesters can undergo hydrolysis under high pressure and temperature (as is usually the case in subterranean zones) to produce an acid. Some additional non-limiting examples of acid-generating material include polycaprolactone, polyhydroxybutyrate (such as poly(3-hydroxybutyrate) or poly(4-hydroxybutyrate)), poly(3-hydroxy valerate), poly(ethylene succinate), poly(propylene succinate), poly(butylene succinate), polyhydroxyalkanoate, and copolymers thereof. In some implementations, an average diameter of the acid-generating material is less than or equal to 750 micrometers (μm). In some implementations, an average diameter of the acid-generating material is less than or equal to 450 μm. In some implementations, an average diameter of the acid-generating material is less than or equal to 300 μm. In some implementations, an average diameter of the acid-generating material is less than or equal to 200 μm. In some implementations, an average diameter of the acid-generating material is in a range of from 10 μm to 750 μm or from 37 μm to 750 μm. In some implementations, an average diameter of the acid-generating material is in a range of from 50 μm to 450 μm. In some implementations, a density of the acid-generating material is in a range of from 1 gram per cubic centimeter (g/cc) to 2 g/cc.

In some implementations, a surfactant is introduced to the subterranean zone before introducing the acid-generating material and the proppant to the subterranean zone. The surfactant can coat a portion of the subterranean zone. The surfactant can be anionic or non-ionic. The acid-generating material and the proppant can be introduced to the subterranean zone, and acid generated from the acid-generating material can react with the carbonate mineral at the portion of the subterranean zone that is not coated with surfactant.

At step 104, the mixture of the acid-generating material and the proppant is positioned within created microfractures in the subterranean zone to keep the microfractures open. The mixture of the acid-generating material and the proppant can also be positioned within natural fractures to keep the natural fractures open.

At step 106, the acid-generating material generates an acid in the subterranean zone and the generated acid reacts with the carbonate mineral in the subterranean zone. The reaction between the carbonate mineral and the generated acid can etch the formation in the subterranean zone and create additional fractures and micro-fractures (that is, fractures on the micrometer scale). The fractures created at step 106 can include microfractures, etched fracture surfaces, or a combination of these. In some implementations, the acid-generating material increases the size of existing fractures in the subterranean zone at step 104. In some implementations, the acid-generating material etches the surface of existing fractures in the subterranean zone at step 106.

The proppant is permeable to gas under high pressures (such as pressures encountered in subterranean zones), and interstitial space between individual particles of proppants can be sufficiently large, yet have the mechanical strength to withstand closure stresses to hold fractures open. The proppant can therefore be used to form conductive pathways for hydrocarbons (such as oil and gas) to flow. The proppant can be made of, for example, sand, treated sand, man-made ceramic materials, silica, or combinations thereof. The proppant can be a small-sized proppant. In some implementations, individual particles of the proppant have a maximum dimension that is less than or equal to 1 millimeter. In some implementations, individual particles of the proppant have a maximum dimension that is less than or equal to 150 μm. In some implementations, individual particles of the proppant have a maximum dimension that is less than or equal to 100 μm. In some implementations, individual particles of the proppant have a maximum dimension that is less than or equal to 1 μm. In some implementations, individual particles of the proppant have a maximum dimension less than or equal to 100 nanometers (nm). The individual particles of the proppant can have a maximum dimension in a range between approximately 1 nm to approximately 1 millimeter (mm), in a range between approximately 1 nm to approximately 100 μm, in a range between approximately 1 nm to approximately 1 μm, and in a range between approximately 1 nm to 100 nm. In some implementations, an average diameter of the proppant is less than or equal to 150 μm. In some implementations, an average diameter of the proppant is in a range of from 25 μm to 150 μm. In some implementations, a density of the proppant is in a range of from 1.5 g/cc to 5 g/cc. In some implementations, a density of the proppant is in a range of from 2 g/cc to 4 g/cc. In some implementations, a density of the proppant is in a range of from 2.2 g/cc to 3.8 g/cc.

In cases where the proppant is coated with the acid-generating material, the individual particles of the coated proppant can have a maximum dimension that is less than or equal to 150 μm. In some implementations, individual particles of the coated proppant have a maximum dimension that is less than or equal to 100 μm. In some implementations, individual particles of the coated proppant have a maximum dimension that is less than or equal to 1 μm. In some implementations, individual particles of the coated proppant have a maximum dimension less than or equal to 100 nm. The individual particles of the coated proppant can have a maximum dimension in a range between approximately 1 nm to approximately 1 millimeter (mm), in a range between approximately 1 nm to approximately 100 μm, in a range between approximately 1 nm to approximately 1 μm, and in a range between approximately 1 nm to 100 nm.

FIG. 1B is a schematic that shows a flow profile of particles of the acid-generating material and the proppant settling within a fracture of a subterranean zone. The bulk transport velocity of the acid-generating material and the proppant, for example, from pumping into the subterranean zone, is represented by the flow arrows in the x-plane and ending in a parabolic curve. Gravity (represented by downward arrow, g) causes the particles to settle within the fracture. The settling velocity of the particles can be dependent on the respective densities and sizes of the particles. The settling velocity of the particles can determine the placement of the respective particles within the fracture. It can be beneficial for the particles of the acid-generating material and the proppant to have a substantially uniform settling velocity to optimize conductivity of the proppant-supported fracture.

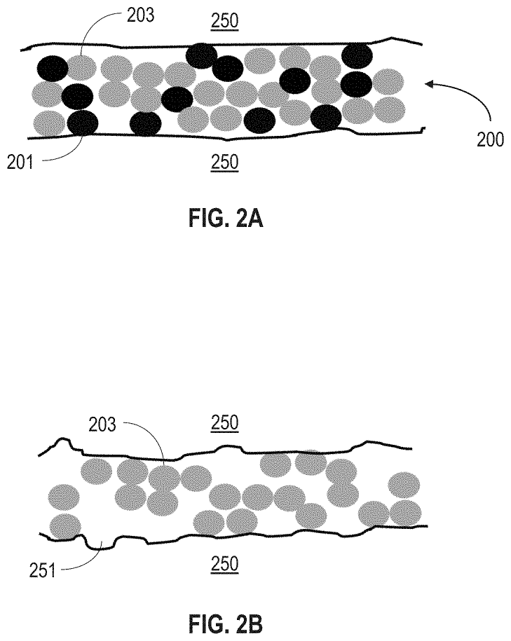

FIGS. 2A and 2B are schematics showing stages of treating a subterranean zone, for example, by method 100. The subterranean zone 250 can include a flow pathway, a fracture, a channel, or combinations thereof through which fluids and solids can flow. As shown in FIG. 2A, a composition 200 including an acid-generating material 201 and a proppant 203 is introduced to the subterranean zone 250. The composition 200 can include multiple layers of acid-generating material 201 and proppant 203. As described earlier, the acid-generating material 201 can generate acid, which can react with carbonate in the subterranean zone 250. As shown in FIG. 2B, the reaction between the acid and the carbonate can etch a surface of the subterranean zone 250 and create fractures 251. The proppant 203 can keep the fractures 251 open.

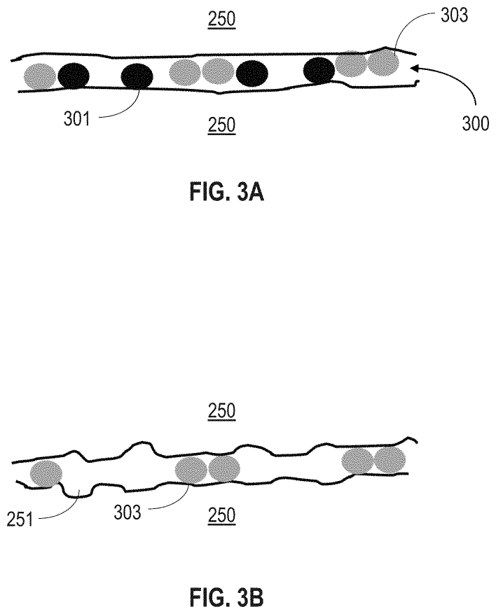

FIGS. 3A and 3B are schematics showing stages of treating a subterranean zone, for example, by method 100. As shown in FIG. 3A, a composition 300 including an acid-generating material 301 and a proppant 303 is introduced to the subterranean zone 250. The acid-generating material 301 can be substantially the same as the acid-generating material 201, and the proppant 303 can be substantially the same as the proppant 203. The composition 300 can include a single layer of acid-generating material 301 and proppant 303. As described earlier, the acid-generating material 301 can generate acid, which can react with carbonate in the subterranean zone 250. As shown in FIG. 3B, the reaction between the acid and the carbonate can etch a surface of the subterranean zone 250 and create fractures 251. The proppant 303 can keep the fractures 251 open.

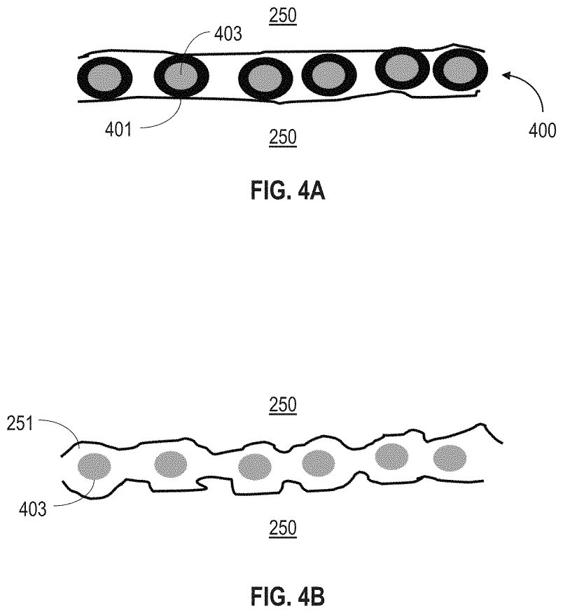

FIGS. 4A and 4B are schematics showing stages of treating a subterranean zone, for example, by method 100. As shown in FIG. 4A, a composition 400 including an acid-generating material 401 and a proppant 403 is introduced to the subterranean zone 250. The acid-generating material 401 can be substantially the same as the acid-generating material 201, and the proppant 403 can be substantially the same as the proppant 203. The proppant 403 can be coated with the acid-generating material 401. Although the composition 400 shown in FIG. 4A includes a single layer of proppant 403 coated in acid-generating material 401, the composition 400 can include multiple layers of proppant 403 coated in acid-generating material 401. As described earlier, the acid-generating material 401 can generate acid, which can react with carbonate in the subterranean zone 250. As shown in FIG. 4B, the reaction between the acid and the carbonate can etch a surface of the subterranean zone 250 and create fractures 251. The proppant 403 can keep the fractures 251 open.

### Example 1

The permeability of natural fractures for three scenarios (without proppant, filled with proppant, and partially filled with proppant) were simulated using combined discrete element method and lattice Boltzmann method (DEM-LBM) simulations. In the DEM-LBM coupling system, a proppant pack was modeled by an assembly of spherical particles in PFC3D (Itasca Consulting Group, Inc.), and the fluid flow in the pore space was computed by LBM. The interaction between the pore fluids and proppants was handled by an immersed boundary scheme. Additional details about the DEM-LBM coupling system can be found in “LBM-DEM modeling of fluid-solid interaction in porous media” by Han and Cundall (International Journal for Numerical and Analytical Methods in Geomechanics 37.10 (2013): 1391-1407).

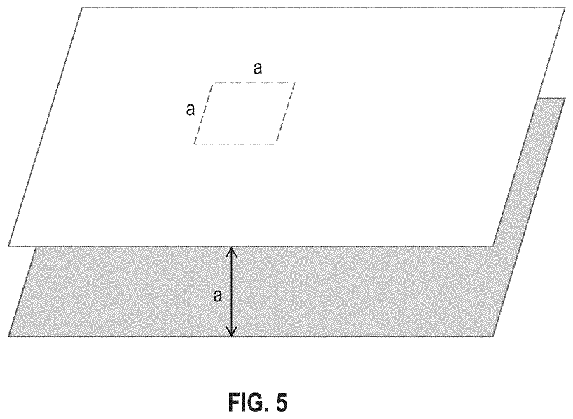

FIG. 5 is a schematic of a fracture, for example, in a subterranean zone, such as a carbonate reservoir. For this example, the fracture was assumed to be planar with an aperture of height α. In relation to the direction of the aperture, the extensions of the fracture were treated as being infinite (that is, boundless) in the other two directions. In the DEM-LBM coupling simulation, a cubic model with edge length α was adopted to represent the fracture, with a periodic condition enforced in the two infinite extension directions.

Scenario 1: Fracture without Proppant

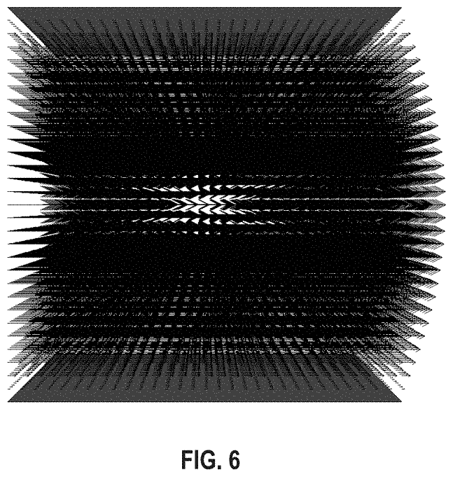

For Scenario 1, the fracture aperture height α was assumed to be 1.35 mm. Water having a density of 1,000 kilograms per cubic meter (kg/m³) and a viscosity of 0.89 Pascal-second (Pa-s) was used as flooding fluid in the permeability measurement. The simulation was driven with gravity of 0.1 meter per square second (m/s²) in the x-direction. Because the Reynolds number was small, laminar flow condition applied. The flux, that is, the discharge per unit area, with units of length per time was measured when fluid flow reached steady state. FIG. 6 shows a schematic of the laminar flow at steady state within the fracture.

The permeability was then calculated using Darcy's law shown in Equation (1).

$$k = - \frac{q}{∇ p} \qquad ( 1 )$$

where k is mobility coefficient (which is permeability divided by viscosity) in square meters per Pascal-second (m²/Pa-s), q is flux in meter per second (m/s), and ∇p is the pressure gradient vector in Pascal per meter (Pa/m). In this case, the pressure gradient vector was equal to ρgₓ, where ρ is density in kg/m³, and gₓ is gravity in the x-direction in m/s². The mobility coefficient is equal to permeability in square meters (m²) divided by viscosity in Pa-s, which means that the permeability is proportional to the mobility coefficient.

Scenario 2: Fracture Filled with Proppant

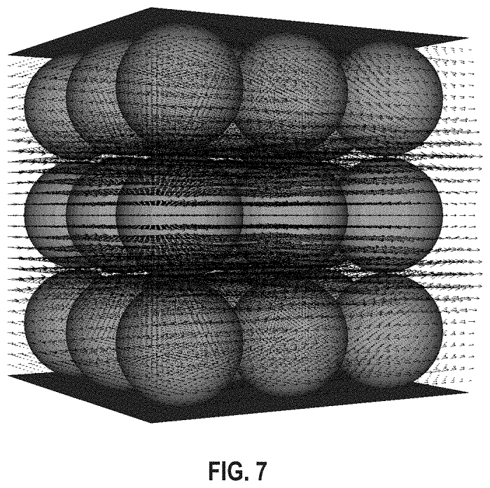

The proppant was modeled as spherical particles having a diameter of 0.45 mm. Three layers of proppants fit within the aperture of the fracture. FIG. 7 shows a schematic of the fluid flow within the fracture filled with proppant at steady state. The mobility coefficient was calculated using Darcy's law shown in Equation (1).

Scenario 3: Fracture Partially Filled with Proppant

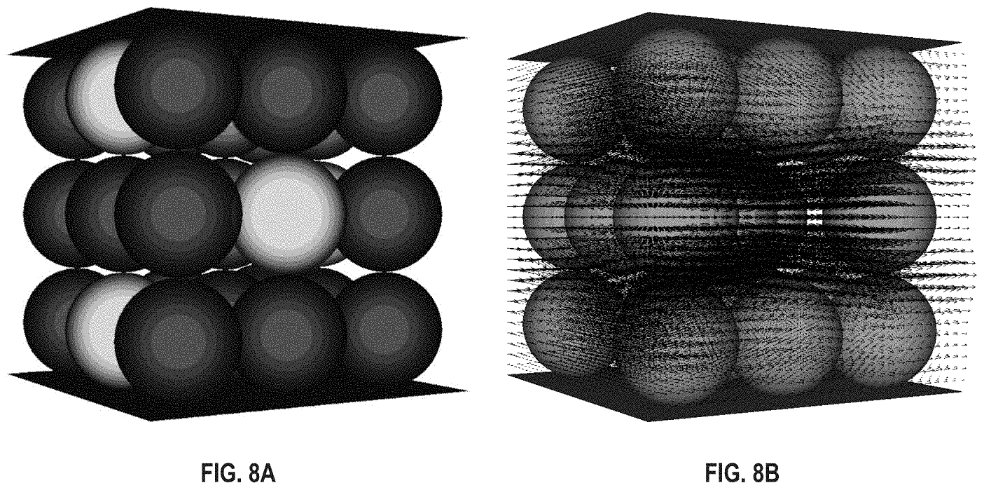

Some proppant can be removed by chemical treatment. As such, the permeability of the proppant pack can increase. To illustrate this effect, several proppants (the lighter spherical particles in FIG. 8A) were removed from the model of Scenario 2. FIG. 8A shows a schematic of the fracture packed with proppant. The darker proppant particles are the proppant particles that will stay within the fracture, while the lighter proppant particles are the proppant particles that are to be removed from the fracture. FIG. 8B shows a schematic of the fluid flow within the fracture at steady state after some of the proppant particles (the lighter proppant particles in FIG. 8A) have been removed. The mobility coefficient was calculated using Darcy's law shown in Equation (1).

The mobility coefficients measured from the DEM-LBM simulations are summarized in Table 1. The simulation results provided in Table 1 represent a case in which the microfracture does not close (ideal). In reality, the aperture of the microfracture will likely significantly reduce after hydraulic stimulation has been completed, and the fluid pressure within the microfracture decreases.

TABLE 1

| Scenario | Mobility coefficient (m²/Pa-s) |
|---|---|
| 1: Fracture without proppant | 1.36 × 10⁻¹⁰ |
| 2: Fracture filled with proppant | 1.09 × 10⁻¹² |
| 3: Fracture partially filled with proppant | 1.84 × 10⁻¹² |

### Example 2

A study was performed on tight organic-rich carbonate source rock samples obtained from an outcrop from Eagle Ford shale. 100 mesh (about 150 micrometers in diameter) white sand was used in this study. The acid-generating material used in this study was polyglycolic acid (PGA) with an average size of 200 micrometers. Half-core Eagle Ford outcrop plugs were obtained by splitting a full core of 1.0 inch in diameter by 1.0 inch in length using a trim saw in the longitudinal direction. The cut rock surfaces where then finely trimmed using a target surface trimmer.

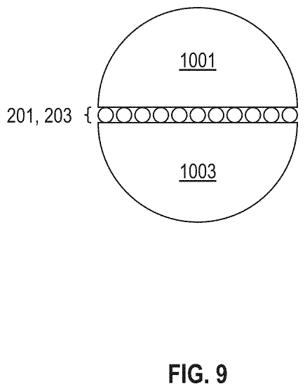

FIG. 9 is a schematic showing an example composite core assembly 900. The composite core assembly 900 included a half-core spacer 901 made of hastelloy and the half-core Eagle Ford outcrop plug 903 (described in the previous paragraph and also referred as the half-core sample). The aperture between the two halves 901 and 903 was used to simulate the width of a filled microfracture in the shale. The width of the aperture was about 150 micrometers. Acid-generating material 201 (PGA), proppant 203 (100 mesh white sand), or both (depending on the test) were placed in this aperture. The composite core assembly 900 was placed into a hastelloy core holder for testing high pressure and high temperature. The confining pressure was set at 2,000 pounds per square inch gauge (psig) and backpressure was maintained at 1,000 psig throughout each core flooding test. For each core flooding test, 2% potassium chloride (KCl) solution was used as the flow media. Differential pressure across the composite core assembly 900 was measured throughout each core flooding test.

After thermal treatment, the half-core sample 903 was removed from the core holder, and the etched surface was analyzed to identify the change in morphology caused by any chemical reactions (for example, due to the acid-generating material 201). The texture and surface profile of the half-core sample 903 was analyzed using a Nanovea PS50 profilometer. The profilometer measured a physical wavelength that was directly related to a specific height and did not require the use of complex algorithms. The surface characterization was conducted for each of the half-core samples 903 before and after chemical treatment in order to identify the change in morphology caused by the chemical reaction(s).

Sample 1: Acid-Generating Material and Sand Intermixed

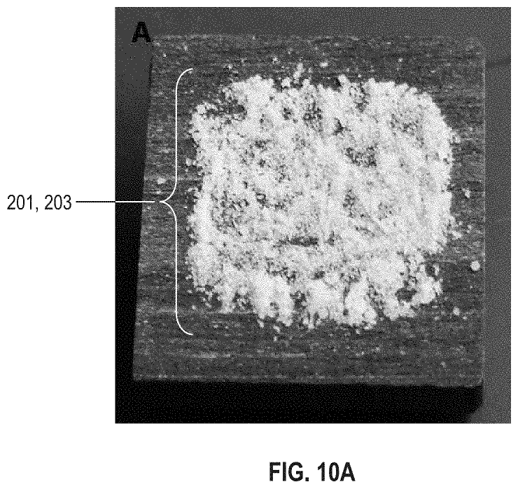

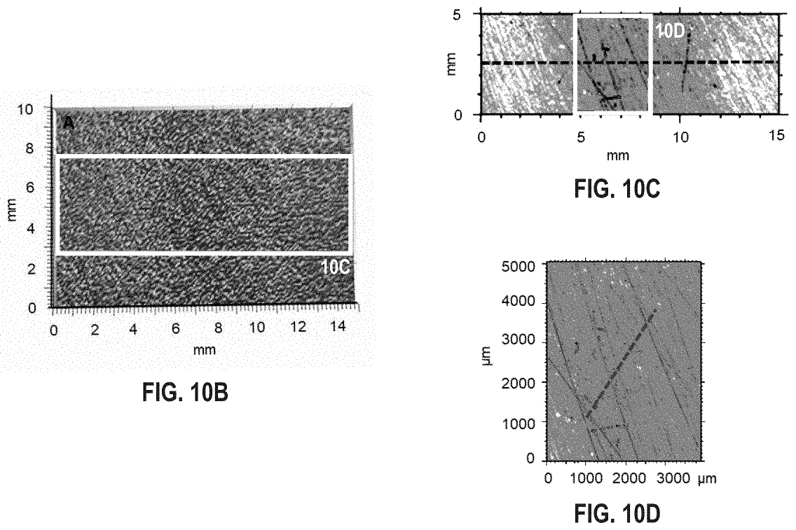

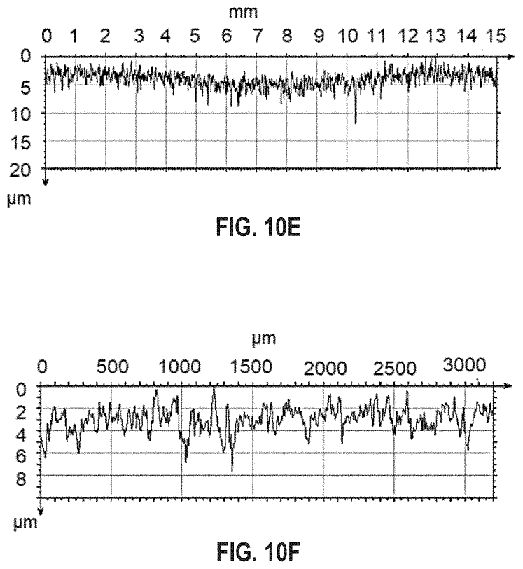

FIG. 10A is a photograph of an acid-generating material 201 and sand 203 (intermixed with one another) on a half-core sample 903. 23.9 milligrams (mg) of PGA 201 and 31.9 mg of 100 mesh white sand 203 were placed on the surface of the half-core sample 903. The testing temperature for the core flooding test was 180 degrees Fahrenheit (° F.). 2% KCl was flowed through the composite core assembly 900 during the core flooding test at a rate of 1 milliliter per minute (mL/min) for 3 hours. The composite core assembly 900 was shut-in within the core holder overnight. No further fluid flow was conducted, and the composite core assembly 900 was then removed from the core holder.

FIG. 10B is a surface scan (15 millimeters by 10 millimeters) of the half-core sample 903 of FIG. 10A prior to being treated with the acid-generating material 201 and the sand 203. The surface of the half-core sample 903 was relatively uniform, and the small grooves generated during the core preparation process were measured to be in a range from about 1 micrometer to about 5 micrometers. FIG. 10C is a magnified scan of the area in the rectangle (15 millimeters by 5 millimeters) of FIG. 10B, and FIG. 10E is a height profile along the dashed line of FIG. 10C. FIG. 10D is a magnified scan of the area in the rectangle (4 millimeters by 5 millimeters) of FIG. 10C, and FIG. 10F is a height profile along the dashed line of FIG. 10D.

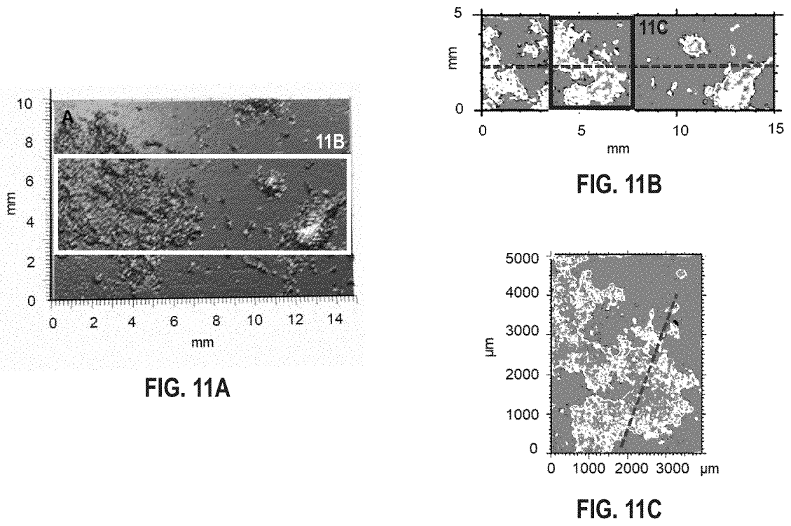

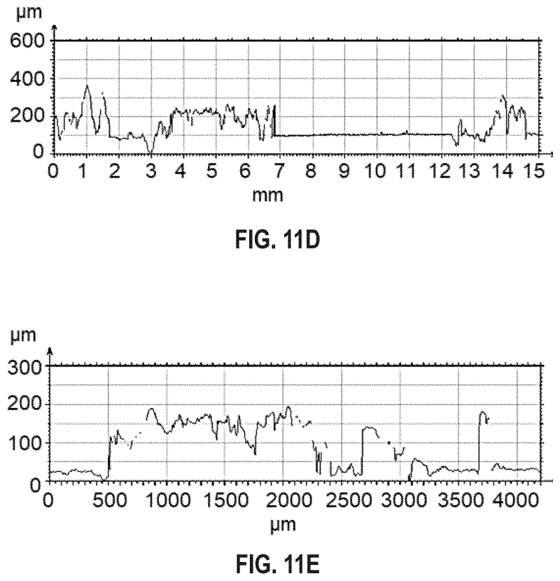

FIG. 11A is a surface scan (15 millimeters by 10 millimeters) of the half-core sample 903 of FIG. 10A after undergoing core flooding and subsequent removal of the sand 203. FIG. 11B is a magnified scan of the area in the rectangle (15 millimeters by 5 millimeters) of FIG. 11A, and FIG. 11D is a height profile along the dashed line of FIG. 11B. The height of the solids coverage in FIG. 11D was about 100 micrometers to about 150 micrometers, which was similar to the aperture size of the composite core assembly 900. FIG. 11C is a magnified scan of the area in the rectangle (4 millimeters by 5 millimeters) of FIG. 11B, and FIG. 11E is a height profile along the dashed line of FIG. 11C. The height of the solids coverage in FIG. 11E was about 100 micrometers to about 150 micrometers, which was in the same range of the aperture of the composite core assembly 900 (about 150 micrometers, similar to the diameter of the 100 mesh sand 203).

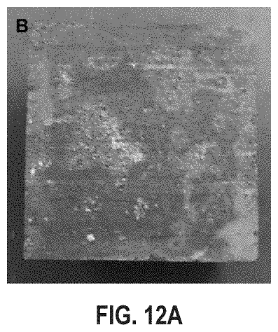

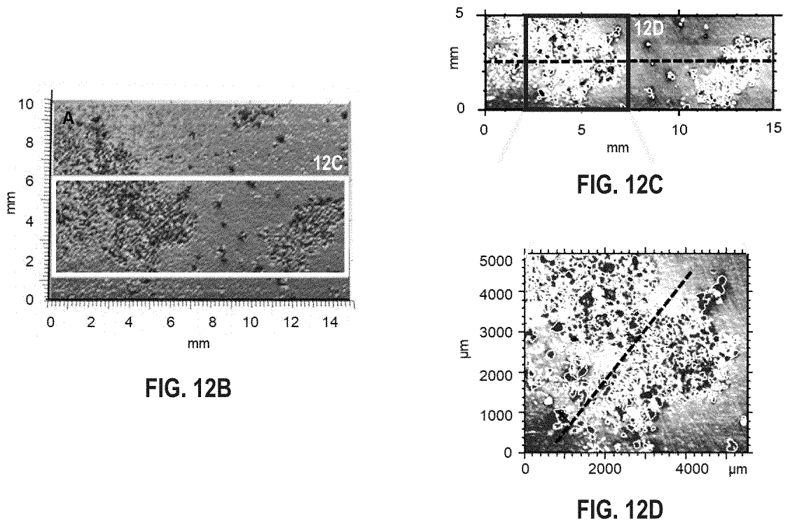

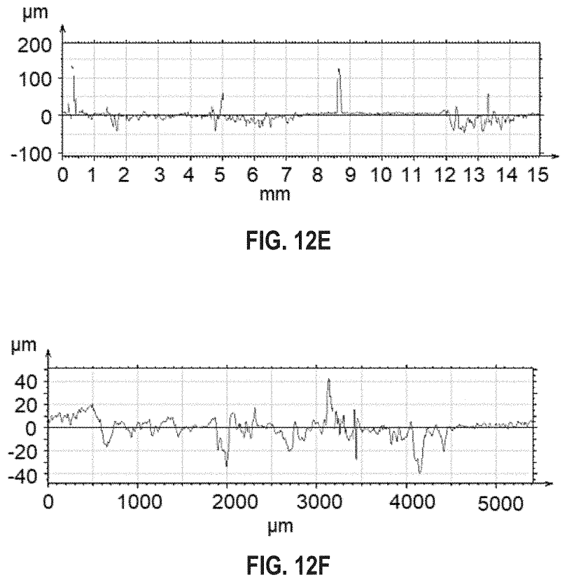

FIG. 12A is a photograph of the half-core sample 903 of FIG. 10A after undergoing core flooding and subsequent removal of the acid-generating material 201 and the sand 203. The acid-generating material 201 and the sand 203 were removed from the half-core sample 903 by blowing the half-core sample 903 with an air nozzle. The surface of the half-core sample 903 was rougher than the original surface (compare with FIG. 10B). The depth of the etched areas ranged from about 5 micrometers to about 40 micrometers.

FIG. 12B is a surface scan (15 millimeters by 10 millimeters) of the half-core sample 903 of FIG. 12A. FIG. 12C is a magnified scan of the area in the rectangle (15 millimeters by 5 millimeters) of FIG. 12B, and FIG. 12E is a height profile along the dashed line of FIG. 12C. FIG. 12D is a magnified scan of the area in the rectangle (5.5 millimeters by 5 millimeters) of FIG. 12C, and FIG. 12F is a height profile along the dashed line of FIG. 12D.

Sample 2: Acid-Generating Material without Sand

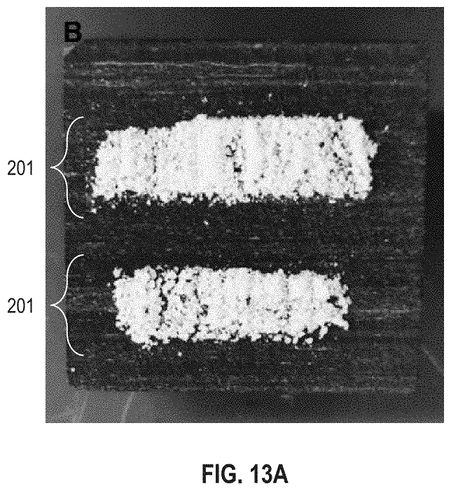

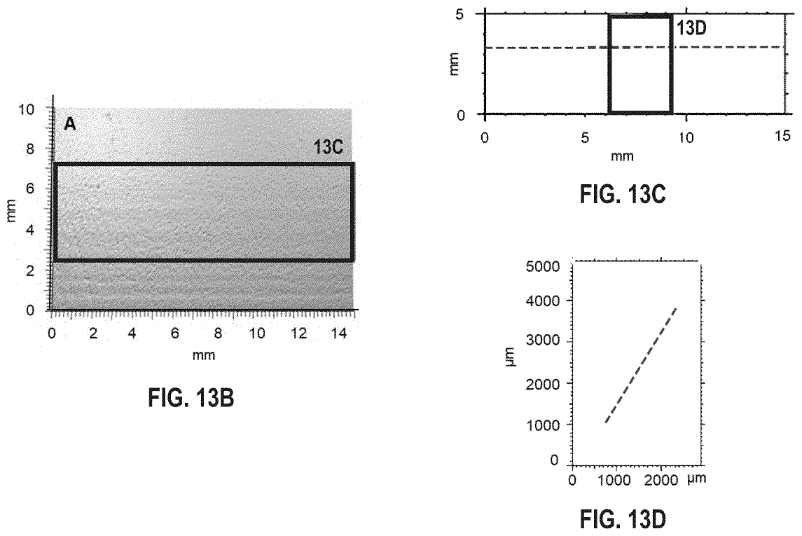

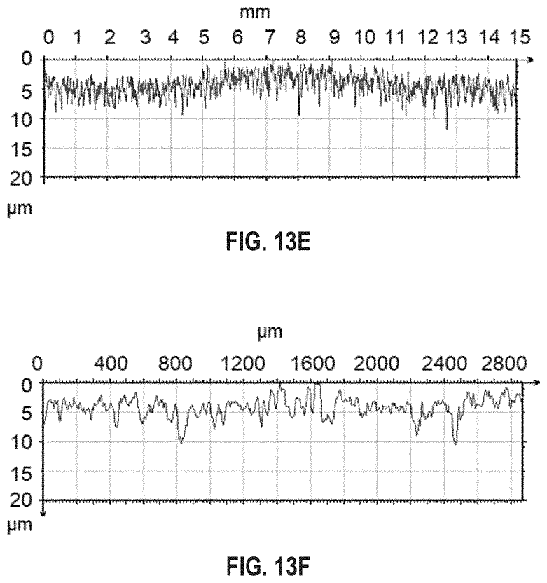

FIG. 13A is a photograph of an acid-generating material 201 on a half-core sample 903. 51.9 mg of PGA 201 was placed on the surface of the half-core sample 903. No sand was placed on this half-core sample 903. The testing temperature for the core flooding test was 180° F. 2% KCl was flowed through the composite core assembly 900 during the core flooding test at a rate of 0.001 mL/min for 90 hours. The composite core assembly 900 was then removed from the core holder.

FIG. 13B is a surface scan (15 millimeters by 10 millimeters) of the half-core sample 903 of FIG. 13A prior to being treated with the acid-generating material 201. Similar to that of the half-core sample 903 of FIG. 10B, the surface of the half-core sample 903 of FIG. 13A was relatively uniform, and the small grooves generated during the core preparation process were measured to be in a range from about 2 micrometers to about 5 micrometers. FIG. 13C is a magnified scan of the area in the rectangle (15 millimeters by 5 millimeters) of FIG. 13B, and FIG. 13E is a height profile along the dashed line of FIG. 13C. FIG. 13D is a magnified scan of the area in the rectangle (3 millimeters by 5 millimeters) of FIG. 13C, and FIG. 13F is a height profile along the dashed line of FIG. 13D.

After conducting the core flooding test and retrieving the composite core assembly 900 from the core holder, it was found that some acid-generating material 201 remained on the surface of the half-core sample 903. This could have been a result of the slower flow rate of the 2% KCl aqueous solution which might have preferentially flowed around the two columns of the acid-generating material 201, thereby resulting in not exposing the acid-generating material 201 to enough water for full degradation of the acid-generating material 201.

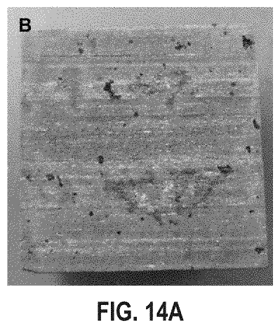

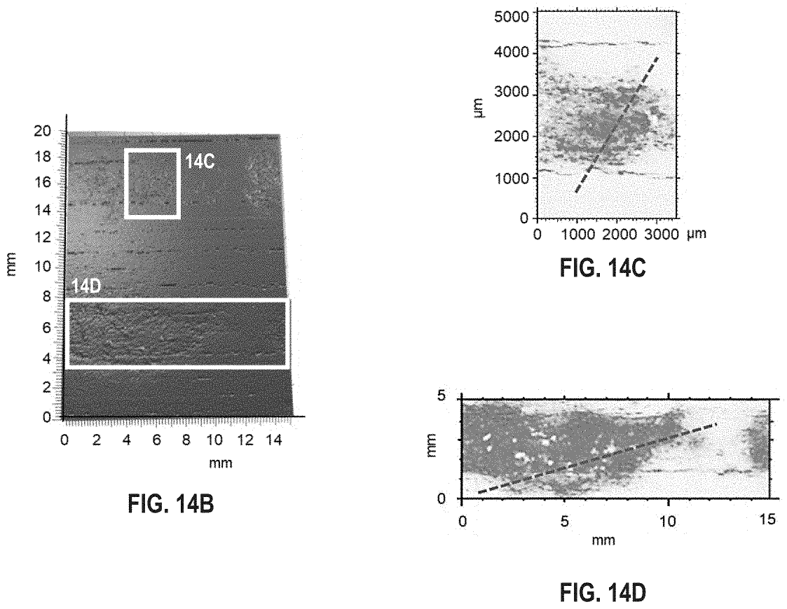

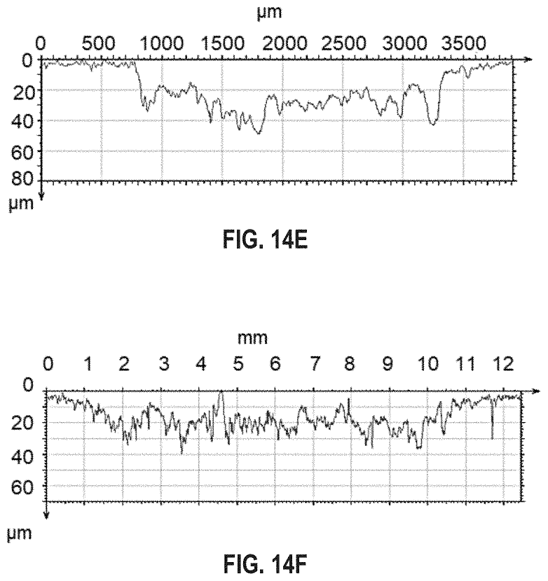

FIG. 14A is a photograph of the half-core sample 903 of FIG. 13A after undergoing core flooding and subsequent removal of the acid-generating material 201. Two rough patches with irregularly shaped pockets were observed at the areas where the acid-generating material 201 was previously packed on the surface of the half-core sample 903. The depth of the irregularly shaped pockets was determined to be from about 10 micrometers to about 50 micrometers, similar to the range observed with Sample 1 (see, for example, FIGS. 12A through 12F).

FIG. 14B is a surface scan (15 millimeters by 20 millimeters) of the half-core sample 903 of FIG. 14A. FIG. 14C is a magnified scan of the area in a rectangle (3.5 millimeters by 5 millimeters) of FIG. 14B, and FIG. 14E is a height profile along the dashed line of FIG. 14C. FIG. 14D is a magnified scan of the area in another rectangle (15 millimeters by 5 millimeters) of FIG. 14B, and FIG. 14F is a height profile along the dashed line of FIG. 14D.

Sample 3: Acid-Generating Material and Sand, Separated and Intermixed

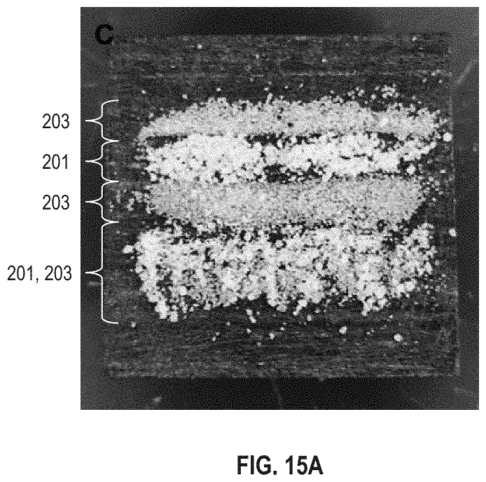

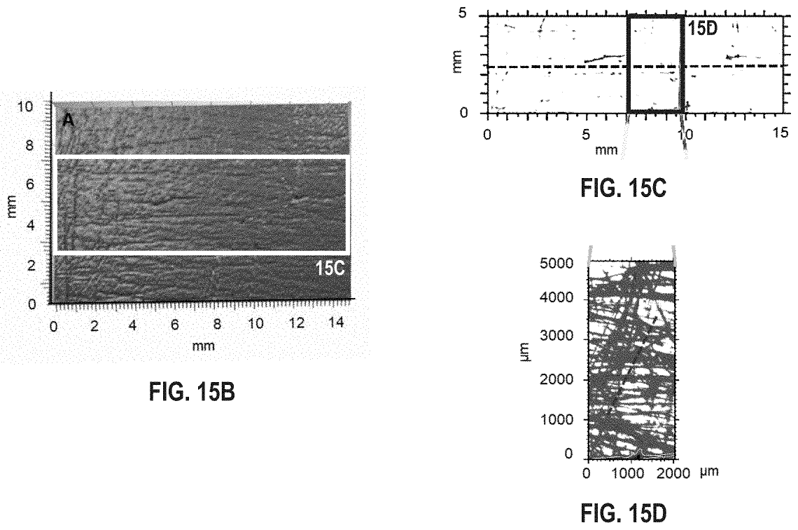

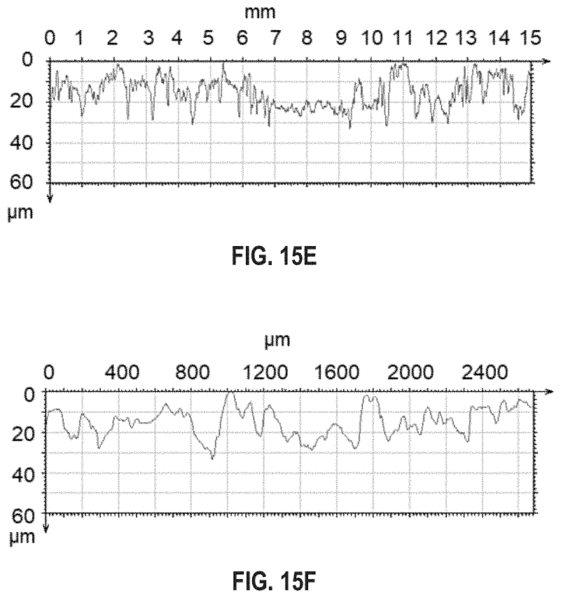

FIG. 15A is a photograph of an acid-generating material 201 and sand 203 on a half-core sample 903. 23.0 milligrams (mg) of PGA 201 and 40.7 mg of 100 mesh white sand 203 were placed on the surface of the half-core sample 903. The PGA 201 and sand 203 were arranged in four arrays (rows) across the half-core sample 903. In order from top to bottom (referring to FIG. 15A), the placed materials were 1) sand 203; 2) acid-generating material 201; 3) sand 203; and 4) intermixed acid-generating material 201 and sand 203. The testing temperature for the core flooding test was 250° F. 2% KCl was flowed through the composite core assembly 900 during the core flooding test at a rate of 0.02 mL/min for 48 hours. Effluent from the core flooding setup was collected using auto-collectors for further analysis. The composite core assembly 900 was then removed from the core holder.

FIG. 15B is a surface scan (15 millimeters by 10 millimeters) of the half-core sample 903 of FIG. 15A prior to being treated with the acid-generating material 201 and the sand 203. Before the acid-generating material 201 and the sand 203 were placed on the surface of the half-core sample 903, the surface of the half-core sample 903 was rubbed with 60 grit sandpaper in order to reduce the potential of solid particle movement during the core flooding test. The grooves generated during the core preparation process were measured to be in a range from about 10 micrometers to about 30 micrometers (slightly deeper than those for Samples 1 and 2). FIG. 15C is a magnified scan of the area in the rectangle (15 millimeters by 5 millimeters) of FIG. 15B, and FIG. 15E is a height profile along the dashed line of FIG. 15C. FIG. 15D is a magnified scan of the area in the rectangle (2 millimeters by 5 millimeters) of FIG. 15C, and FIG. 15F is a height profile along the dashed line of FIG. 15D.

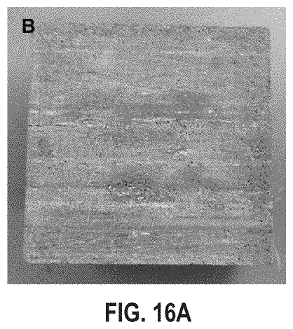

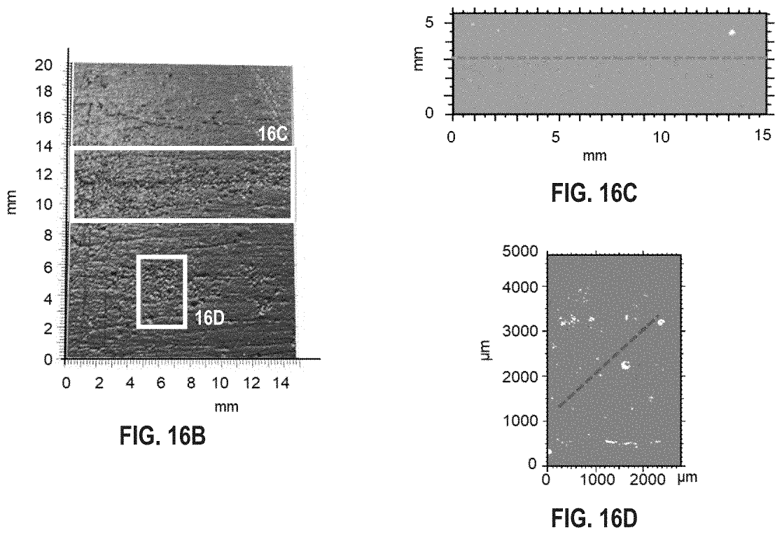

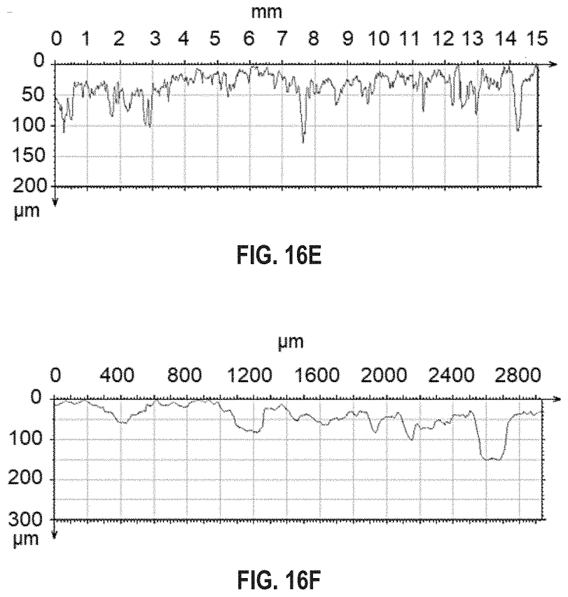

FIG. 16A is a photograph of the half-core sample 903 of FIG. 15A, after undergoing core flooding and subsequent removal of acid-generating material 201 and the sand 203. Two rough patches with irregularly shaped pockets were observed at the areas where the acid-generating material 201 was previously packed on the surface of the half-core sample 903. The depth of the irregularly shaped pockets was determined to be from about 50 micrometers to about 150 micrometers, which was deeper in comparison to the range observed with Samples 1 and 2 (see, for example, FIGS. 12A through 12F and FIGS. 14A through 14F). This increase in depth profile could have been the result of faster reaction kinetics at the increased temperature in comparison to the temperatures implemented for Samples 1 and 2.

FIG. 16B is a surface scan (15 millimeters by 20 millimeters) of the half-core sample 903 of FIG. 16A. FIG. 16C is a magnified scan of the area in a rectangle (5.5 millimeters by 15 millimeters) of FIG. 16B, and FIG. 16E is a height profile along the dashed line of FIG. 16C. FIG. 16D is a magnified scan of the area in another rectangle (3 millimeters by 5 millimeters) of FIG. 16B, and FIG. 16F is a height profile along the dashed line of FIG. 16D.

The experiments conducted on Samples 1, 2, and 3 prove that the acid-generating material 201 was capable of creating voids (for example, dimples) along the flow-path of microfractures by nature of its degradation under the operating conditions (for example, increased temperature) and the chemical reaction between the acid generated by the acid-generating material 201 and the calcite present in the half-core sample 903.

Numerical Modeling

Numerical modeling was employed to predict the permeability change based on the fracture width and the quantified ranges of etched fracture surfaces. The DEM-LBM coupling model proved capable of precisely and accurately capturing the fluid flow in pore space along with the interaction among the pore fluid, solid particles, and confining walls. The model was employed to verify the results of etching with acid-generating material 201 and quantify the change in permeabilities and hydraulic conductivities in the various scenarios explored. The model was employed also to quantify the changes in conductivity due to the placement of proppant 203 in the microfractures and etches formed by the interaction of the acid-generating material 201 and the fracture face (for example, formed on the surface of the half-core sample 903).

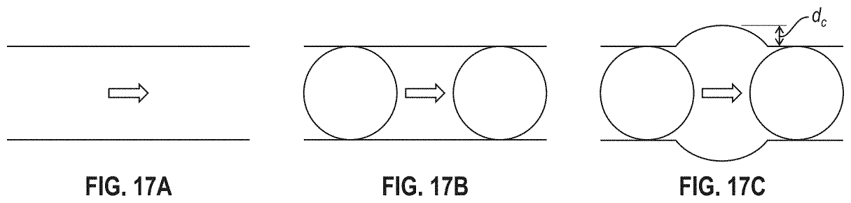

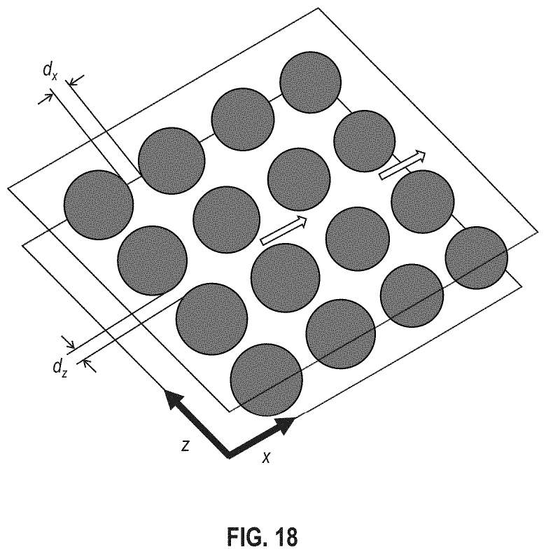

The following Table 2 is applicable to FIGS. 17A, 17B, 17C, and 18. The units of permeability in Table 2 are square meters per Pascal-second (m²/Pa-s). The units of fracture conductivity in Table 2 are cubic meters per Pascal-second (m³/Pa-s). The results provided in Table 2 represent a more realistic situation (in comparison to Table 1), which indicates that the conductivity of the microfracture without proppant is very low (for example, two orders of magnitude less than a majority of the cases associated with the microfracture including proppant).

TABLE 2
Permeabilities of various scenarios measured by DEM-LBM simulations

| | | Particle gap | Etched depth, | | Fracture |
|---|---|---|---|---|---|
| | Fracture width | (micrometers) | d_{c} | Permeability | conductivity |
| Case | (micrometers) | dₓ:d_{z} | (micrometers) | (m²/Pa-s) | (m³/Pa-s) |
| 1 | 5 | — | — | 2.09 × 10⁻⁹ | 1.05 × 10⁻¹⁴ |
| 2 | 150 | 0:0 | — | 1.90 × 10⁻⁸ | 2.85 × 10⁻¹² |
| 3 | 150 | 37.5:37.5 | — | 9.42 × 10⁻⁸ | 1.41 × 10⁻¹³ |
| 4 | 150 | 75:75 | — | 2.87 × 10⁻⁷ | 4.30 × 10⁻¹³ |
| 5 | 150 | 150:150 | — | 6.00 × 10⁻⁷ | 9.00 × 10⁻¹³ |
| 6 | 150 | 75:0 | — | 2.75 × 10⁻⁸ | 4.13 × 10⁻¹² |
| 7 | 150 | 150:0 | — | 3.41 × 10⁻⁸ | 5.12 × 10⁻¹² |
| 8 | 150 | 75:0 | 50 | 4.81 × 10⁻⁸ | 7.21 × 10⁻¹² |
| 9 | 150 | 75:0 | 100 | 4.81 × 10⁻⁸ | 7.21 × 10⁻¹² |
| 10 | 150 | 75:0 | 150 | 4.86 × 10⁻⁸ | 7.28 × 10⁻¹² |
| 11 | 150 | 150:0 | 50 | 6.03 × 10⁻⁸ | 9.04 × 10⁻¹² |
| 12 | 150 | 150:0 | 100 | 6.03 × 10⁻⁸ | 9.05 × 10⁻¹² |
| 13 | 150 | 150:0 | 150 | 6.10 × 10⁻⁸ | 9.15 × 10⁻¹² |

FIG. 17A is a schematic illustrating fluid flow in a fracture without proppant. The fracture was assumed to be 5 micrometers wide. This scenario is applicable to Case 1 in Table 2.

FIG. 17B is a schematic illustrating fluid flow in a fracture with proppant 203. The fracture was assumed to be 150 micrometers wide with the support of the proppant 203. This scenario is applicable to Cases 2-7 in Table 2. Cases 2-7 indicated that the fracture permeability can be increased by a factor of tens to hundreds with proppant 203 support (in comparison to an unsupported fracture, such as Case 1), depending on the particle-to-particle gaps between the proppant 203.

FIG. 17C is a schematic illustrating fluid flow in a fracture with proppant 203 and void space generated by an acid-generating material 201. The fracture was assumed to be 150 micrometers wide with the support of the proppant 203. The corroded depth (d_{c}) in the fracture walls (for example, due to the interaction of the acid-generating material 201 and the fracture face) varied from 50 micrometers to 150 micrometers. This scenario is applicable to Cases 8-13 in Table 2. Cases 8-13 indicated that the fracture permeability can be further increased by the voids created by acid erosion (for example, through the interaction between the acid-generating material 201 and the fracture face).

FIG. 18 is a three-dimensional schematic illustrating fluid flow in a fracture with proppant 203. The fracture walls were assumed to be perpendicular to the y-direction, and therefore the proppant 203 was distributed across an x-z plane. The particle-to-particle gaps between the proppant 203 in the x-direction were uniform (dₓ). The particle-to-particle gaps between the proppant 203 in the z-direction were uniform (d_{z}). The ratio of dₓ to d_{z} varied across the various cases. The arrows signify the direction of fluid flow. In the simulations, the fluid flow was in the general x-direction.

It is noted that fluid transport capacity of a fracture depends not only on the permeability of the material inside the fracture (for example, proppant 203) but also on the width of the fracture aperture. The product of the fracture aperture and its permeability is equal to the fracture conductivity (provided in the last column of Table 2). The fracture conductivity in the cases supported by proppant 203 (cases 2-13) is increased by a factor of hundreds to thousands in relation to that of an unsupported fracture (case 1).

Fluid flow is typically assumed to be in the laminar flow regime in modeling hydraulic fracture propagation. This assumption can fail, however, in certain cases in which a low viscosity fluid (for example, slickwater) is injected at a high rate, resulting in a Reynolds number that is in the turbulent flow regime. This is notably the case for hydraulic fracture propagation in glacier beds in which the Reynolds numbers are expected to be greater than 100,000. In practice, however, the Reynolds number for typical slickwater treatments is expected to be in a range of from about 1,000 to about 100,000, which coincides with the transition range from laminar flow to turbulent flow. Further, the Reynolds number is expected to drop significantly at tip regions of hydraulic fractures, as the fracture width approaches zero.

The settling velocity of a particle (for example, a proppant and/or an acid-generating material) in flowing fluids with a Reynolds number in a range of from about 2 to about 500 can be estimated by Equation (2), proposed by Novotny (1977).

$${v}_{p} = \frac{20.34 {( {ρ}_{p} - {ρ}_{f} )}^{0.71} {d}_{p}^{1.14}}{{ρ}_{f}^{0.29} {μ}^{0.43}} \qquad ( 2 )$$

where dₚ is the diameter of the particle, ρₚ is the density of the particle, ρ_{f} is the density of the carrying fluid (for example, the fracturing fluid), and μ is the viscosity of the carrying fluid.

The settling velocity of a particle in flowing fluids with a Reynolds number greater than about 500 can be estimated by Equation (3), proposed by Novotny (1977).

$${v}_{p} = 1.74 \sqrt{\frac{g ( {ρ}_{p} - {ρ}_{f} ) {d}_{p}}{{ρ}_{f}}} \qquad ( 3 )$$

where g is the acceleration of gravity.

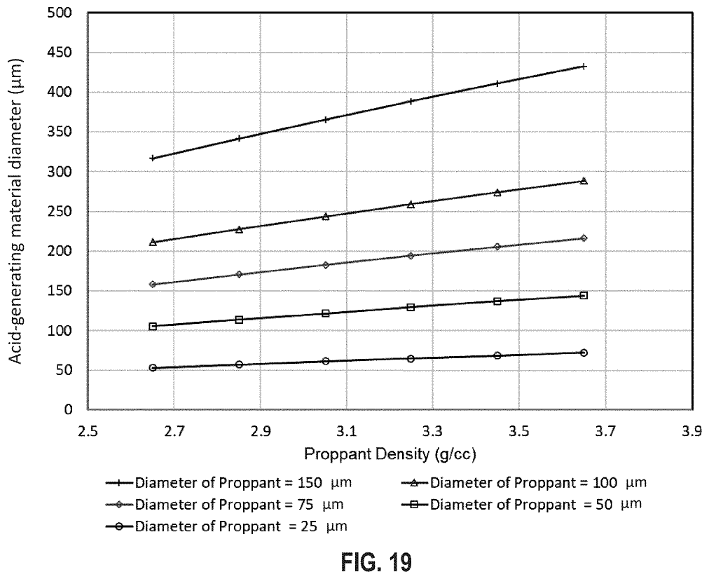

FIG. 19 is a graph illustrating various combinations of acid-generating material diameter, proppant diameter, and proppant density that result in the acid-generating material and the proppant in having substantially the same settling velocity in fractures. Equation (2) was used in the calculation. The graph of FIG. 19 is a visual representation of the data provided in Table 3.

TABLE 3
Proppant and acid-generating material
dimensions for same settling velocity

| | | Acid-generating | | |
|---|---|---|---|---|
| Proppant | Proppant | material | AGM | AGM:proppant |
| density | diameter | (AGM) density | diameter | diameter |
| (g/cc) | (micron) | (g/cc) | (micron) | ratio |
| 2.65 | 150 | 1.53 | 316.6 | 2.11 |
| 2.65 | 100 | 1.53 | 211.1 | 2.11 |
| 2.65 | 75 | 1.53 | 158.3 | 2.11 |
| 2.65 | 50 | 1.53 | 105.5 | 2.11 |
| 2.65 | 25 | 1.53 | 52.8 | 2.11 |
| 2.85 | 150 | 1.53 | 341.4 | 2.28 |
| 2.85 | 100 | 1.53 | 227.6 | 2.28 |
| 2.85 | 75 | 1.53 | 170.7 | 2.28 |
| 2.85 | 50 | 1.53 | 113.8 | 2.28 |
| 2.85 | 25 | 1.53 | 56.9 | 2.28 |
| 3.05 | 150 | 1.53 | 365.2 | 2.43 |
| 3.05 | 100 | 1.53 | 243.5 | 2.44 |
| 3.05 | 75 | 1.53 | 182.6 | 2.43 |
| 3.05 | 50 | 1.53 | 121.7 | 2.43 |
| 3.05 | 25 | 1.53 | 60.9 | 2.44 |
| 3.25 | 150 | 1.53 | 388.3 | 2.59 |
| 3.25 | 100 | 1.53 | 258.9 | 2.59 |
| 3.25 | 75 | 1.53 | 194.2 | 2.59 |
| 3.25 | 50 | 1.53 | 129.4 | 2.59 |
| 3.25 | 25 | 1.53 | 64.7 | 2.59 |
| 3.45 | 150 | 1.53 | 410.7 | 2.74 |
| 3.45 | 100 | 1.53 | 273.8 | 2.74 |
| 3.45 | 75 | 1.53 | 205.3 | 2.74 |
| 3.45 | 50 | 1.53 | 136.9 | 2.74 |
| 3.45 | 25 | 1.53 | 68.4 | 2.74 |
| 3.65 | 150 | 1.53 | 432.5 | 2.88 |
| 3.65 | 100 | 1.53 | 288.3 | 2.88 |
| 3.65 | 75 | 1.53 | 216.2 | 2.88 |
| 3.65 | 50 | 1.53 | 144.2 | 2.88 |
| 3.65 | 25 | 1.53 | 72.1 | 2.88 |

As used in this disclosure, the term “subterranean material” or “subterranean zone” refers to any material under the surface of the earth, including under the surface of the bottom of the ocean. For example, a subterranean zone or material can be any section of a wellbore and any section of a subterranean hydrocarbon- or water-producing formation or region in fluid contact with the wellbore. Placing a material in a subterranean zone can include contacting the material with any section of a wellbore or with any subterranean region in fluid contact the material. Subterranean materials can include any materials placed into the wellbore such as cement, drill shafts, liners, tubing, casing, or screens; placing a material in a subterranean zone can include contacting with such subterranean materials. In some examples, a subterranean zone or material can be any downhole region that can produce liquid or gaseous hydrocarbon materials, water, or any downhole section in fluid contact with liquid or gaseous hydrocarbon materials, or water. For example, a subterranean zone or material can be at least one of an area desired to be fractured, a fracture or an area surrounding a fracture, and a flow pathway or an area surrounding a flow pathway, in which a fracture or a flow pathway can be optionally fluidly connected to a subterranean hydrocarbon- or water-producing region, directly or through one or more fractures or flow pathways.

As used in this disclosure, “treatment of a subterranean zone” can include any activity directed to extraction of water or hydrocarbon materials from a subterranean hydrocarbon- or water-producing formation or region, for example, including drilling, stimulation, hydraulic fracturing, clean-up, acidizing, completion, cementing, remedial treatment, abandonment, aquifer remediation, identifying oil rich regions via imaging techniques, and the like.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

As used in this disclosure, the term “solvent” refers to a liquid that can dissolve a solid, another liquid, or a gas to form a solution. Non-limiting examples of solvents are silicones, organic compounds, water, alcohols, ionic liquids, and supercritical fluids.

As used in this disclosure, the term “drilling fluid” refers to fluids, slurries, or muds used in drilling operations downhole, such as during the formation of the wellbore.

As used in this disclosure, the term “stimulation fluid” refers to fluids or slurries used downhole during stimulation activities of the well that can increase the production of a well, including perforation activities. In some examples, a stimulation fluid can include a fracturing fluid or an acidizing fluid.

As used in this disclosure, the term “fracturing fluid” refers to fluids or slurries used downhole during fracturing operations.

As used in this disclosure, the term “remedial treatment fluid” refers to fluids or slurries used downhole for remedial treatment of a well. Remedial treatments can include treatments designed to increase or maintain the production rate of a well, such as stimulation or clean-up treatments.

As used in this disclosure, the term “fluid” refers to liquids and gels, unless otherwise indicated.

As used in this disclosure, a “flow pathway” downhole can include any suitable subterranean flow pathway through which two subterranean locations are in fluid connection. The flow pathway can be sufficient for hydrocarbons or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some implementations, a flow pathway can be a water source and can include water. In some implementations, a flow pathway can be a hydrocarbon source and can include hydrocarbons. In some implementations, a flow pathway can be sufficient to divert water, a downhole fluid, or a produced hydrocarbon from a wellbore, fracture, or flow pathway connected to the pathway.

While this disclosure contains many specific implementation details, these should not be construed as limitations on the scope of the subject matter or on the scope of what may be claimed, but rather as descriptions of features that may be specific to particular implementations. Certain features that are described in this disclosure in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example implementations do not define or constrain this disclosure. Other changes, substitutions, and alterations are also possible without departing from the spirit and scope of this disclosure.

What is claimed is:

1. A method for treating a subterranean zone, the method comprising:
introducing an acid-generating material and a proppant to the subterranean zone, wherein a ratio of an average diameter of the acid-generating material to an average diameter of the proppant is in a range of from 1.5:1 to 5:1, the subterranean zone comprising fractures;
positioning the acid-generating material and the proppant in the fractures of the subterranean zone; and
generating, by the acid-generating material, acid within the subterranean zone to create microfractures in the subterranean zone.

2. The method of claim 1, wherein introducing the acid-generating material and the proppant to the subterranean zone comprises:
mixing the acid-generating material and the proppant to form a mixture; and
introducing the mixture to the subterranean zone.

3. The method of claim 2, wherein the mixture comprises a plurality of layers, each of the layers comprising the acid-generating material and the proppant.

4. The method of claim 2, wherein the subterranean zone comprises carbonate mineral.

5. The method of claim 4, wherein creating the fractures in the subterranean zone using the acid-generating material comprises:
generating an acid in the subterranean zone with the acid-generating material; and
reacting the carbonate mineral with the generated acid.

6. The method of claim 5, wherein the acid-generating material comprises a degradable ester.

7. The method of claim 6, wherein the degradable ester comprises polylactic acid, polyglycolic acid, or combinations thereof.

8. The method of claim 3, wherein the proppant has a maximum dimension less than or equal to 150 micrometers (μm).

9. The method of claim 8, wherein the proppant has a maximum dimension less than or equal to 1 μm.

10. The method of claim 9, wherein the proppant has a maximum dimension less than or equal to 100 nanometers (nm).

11. The method of claim 1, wherein the ratio of the average diameter of the acid-generating material to the average diameter of the proppant is in a range of from 1.5:1 to 3:1.

12. The method of claim 11, wherein a ratio of a density of the proppant to a density of the acid-generating material is in a range of from 1:1 to 2.5:1.

13. The method of claim 12, wherein the average diameter of the proppant is less than or equal to 150 micrometers.

14. A composition for treating a subterranean zone comprising carbonate mineral, the composition comprising:
an acid-generating material comprising a degradable ester, the acid-generating material configured to generate an acid that reacts with the carbonate mineral which results in creating fractures in the subterranean zone; and
a proppant, wherein:
a ratio of an average diameter of the acid-generating material to an average diameter of the proppant is in a range of from 1.5:1 to 5:1, and
a ratio of a density of the proppant to a density of the acid-generating material is in a range of from 1.5:1 to 2.5:1.

15. The composition of claim 14, wherein the ratio of the average diameter of the acid-generating material to the average diameter of the proppant is in a range of from 2:1 to 3:1.

16. The composition of claim 15, wherein the composition comprises a plurality of layers, and each of the layers comprise the acid-generating material and the proppant.

17. The composition of claim 15, wherein the degradable ester comprises polylactic acid, polyglycolic acid, or combinations thereof.

18. The composition of claim 17, wherein the average diameter of the proppant is less than or equal to 150 micrometers.

19. A method for treating a subterranean zone, the subterranean zone having natural microfractures, the method comprising:
introducing a mixture of an acid-generating material and a small-sized proppant to the subterranean zone, wherein a ratio of an average diameter of the acid-generating material to an average diameter of the proppant is in a range of from 1:1 to 5:1, and the small-sized proppant has a maximum dimension less than or equal to 150 micrometers (μm);
creating induced microfractures in the subterranean zone using the mixture of the acid-generating material and the small-size proppant; and
positioning the small-sized proppant within both the natural microfractures and the induced microfractures to keep the natural microfractures and the induced microfractures open.
